(19) United States
(12) Patent Application Publication
(10) Pub. No.: US 2010/0073839 A1
(43) Pub. Date: Mar. 25, 2010

(54) Systems and Methods for Detecting Unsafe Thermal Conditions in Wiring Devices

(76) Inventors: Michael Baxter, Hillsboro, OR (US); Glenn Spacht, Lloyd Neck, NY (US)

Correspondence Address: Michael F. Krieger;Kirton & McConkie, 60 East South Temple, Suite 1800, Salt Lake City, UT, 84111, US

(21) Appl. No.: 12/625,127

(22) Filed: Nov. 24, 2009

Related U.S. Application Data
(63) Continuation-in-part of application No. 12/236,400, filed on Sep. 23, 2008.

(51) Int. Cl. H02H 5/04

(52) U.S. Cl. 361/103

(57) ABSTRACT

Systems and methods that provide improved detection of series fault and other localized unsafe heating conditions are described. The systems and methods provide an increased range of response possibilities upon detection of such conditions. Multiple temperature sensors are located in close proximity with the location of potential over-heating events, and differential temperature sensing is used to detect over-heating events. Electronic sensors in accordance with implementations of the present invention detect overheating conditions at lower temperatures and more quickly because of the close proximity of the sensors to locations of potential overheating and because of the differential temperature sensing, thereby improving the safety of electrical wiring devices and fixtures.

### CROSS-REFERENCE TO RELATED APPLICATIONS

This application is a continuation-in-part of prior application Ser. No. 12/236,400, filed Sep. 23, 2008.

### BACKGROUND OF THE INVENTION

1. Field of the Invention

The present invention relates to electrical fixtures and wiring devices, and more particularly to systems and methods for detecting unsafe thermal conditions in fixtures and wiring devices.

2. Background and Related Art

Many building fires occur because of unsafe heating associated with power outlets, light switches or other fixture. For example, loose connections cause points of excessive heating under normal use. If not detected, this localized heating leads to fires by igniting wire insulation, fixture materials, framing, or other nearby flammable objects. The fires caused by the excessive localized heating result in property loss, injury and even death.

These points of excessive heating are most commonly found at the wiring connection to the fixture, but can be found at any location where an electrical connection is made. The excessive heating happens for one of several different reasons that include: an installer who neglects to tighten or fully tighten screws on the supply wires, regular use that loosens supply wire connections, supply wire connection materials that become oxidized, an unqualified installer who connects supply wires improperly, components involved in making or breaking an electrical connection wearing with use, localized arcing associated with making or breaking an electrical connection causes oxidation of the involved components, and/or poor construction of the involved components. Any of these conditions/causes leads to unexpected electrical resistance at the connection point, and electrical current flowing through the higher-than-expected electrical resistance causes the overheating and fires described above.

In a receptacle, the main locations of possible excessive heating are the supply wire terminal screws and the plug blade contacts. In a light switch, the main locations of possible excessive heating are the supply wire terminal screws and the switch contacts. In some instances, abnormally-high electrical resistance may develop over time, leading to overheating.

FIG. 1 illustrates the effect of localized overheating. The left-most screw of the illustrated plug receptacle was not tightened sufficiently and overheated, melting the insulation on the supply wire. Furthermore, the screw oxidized, increasing the excessive heating and leading to melted plastic and a destructive fire.

Attempts have been made to create electrical wiring devices, such as plug receptacles and outlets, that detect heating and that discontinue electrical power draw to eliminate the overheating condition. Currently-available devices and methods rely on bimetallic thermal sensors acting as a switch to cause a disconnect in the electrical current. When the electrical current is interrupted, the power delivered to the high-resistance connection stops, along with the heating generated by the power lost at the connection. Such devices have proved difficult to implement. For example, typical bimetallic thermal sensors/switches, such as one of brass and invar, have a switching threshold of approximately 200 degrees Fahrenheit. While most plastic household wiring insulation and outlet housings do not melt until temperatures reach or exceed approximately 300 degrees Fahrenheit, operation approaching 200 degrees Fahrenheit has a high probability of causing distortion of the materials. Additionally, it is possible for heat to exceed 200 degrees Fahrenheit in one location of the device before the bimetallic switch itself is heated sufficiently to cause thermal switching. Because of the bulk of typical bimetallic switches, it is difficult to locate such switches close to the locations of potential heating, and thus such bimetallic switches fail to adequately protect against over-heating even when they have a lower temperature threshold for switching.

Some approaches have tried to address differences in heating location by using multiple bimetallic switches or using heat-conductive materials in the devices. Such attempts lead to higher manufacturing costs and also fail to address the fact that the 200-degree threshold of the bimetallic thermal switching, while preventive of fires, fails to prevent material distortion with its attendant risks and difficulties.

Current circuit breakers and fuses are unable to detect points of excessive heating, because they measure electric current rather than temperature. The electric current flowing through a point of excessive heating is typically within the range of normal current flow of circuit breakers and fuses. Arc Fault Circuit Interrupters (AFCI) are a type of circuit breaker technology that is capable of detecting parallel faults, or faults between line and neutral that are in parallel with the outlet or device. AFCI devices do not provide protection against series faults that lead to glowing connections (overheating) and subsequent fires.

### BRIEF SUMMARY OF THE INVENTION

Implementation of the invention provides improved detection of series fault conditions, and provides improved response possibilities upon detection of such conditions. Some implementations of the invention utilize electronic temperature sensors such as solid-state sensors and temperature sensors integrated into an integrated circuit. In some implementations, the electronic temperature sensors are connected to a printed circuit board (PCB) that is connected to supply wire connectors, and in other implementations they are directly connected to supply wire connectors. In some implementations, differential temperature sensing, as an alternative to or in addition to direct temperature sensing, is provided.

The electronic temperature sensors can be quite small, and can therefore be located more closely to or directly on the supply wire connectors, which improves the rapidity with which localized heating can be detected. As the electronic sensors can be connected to PCBs and to other circuits, functionalities can be implemented using the PCBs and/or other circuits that cannot be provided with simple switching-type thermal sensors. Non-limiting examples of such additional functionality include integrated ground-fault detection, integrated safety features such as open-circuit, short-circuit, and ground fault detection, and integrated notification of detected fault conditions.

Electronic sensors in accordance with implementations of the present invention are capable of detecting overheating conditions at temperatures below those detected by current bimetallic temperature sensors, thereby improving the safety of electrical wiring devices and fixtures. Additionally, using electronic sensors, the threshold temperature for response can be selected or controlled to be at a variety of temperatures, including temperatures lower than those available with current bimetallic switching sensors. Detecting heating events and disconnecting power at lower temperatures improves safety. Implementations of the invention may be incorporated into any type of wired electrical device, electrical fixture, or wiring device.

Implementation of the invention provides a system for detecting unsafe thermal conditions in wiring devices including a wiring device having a plurality of terminals for attaching electrical wires to the wiring device, a plurality of temperature sensors, at least one temperature sensor being in close proximity to each terminal, and circuitry configured to monitor the temperature sensors and to interrupt power to the wiring device when a first temperature of one or more of the temperature sensors differs from a second temperature of at least one other of the temperature sensors more than a reference temperature differential. Some implementations of the system provide a wiring device having electrical contact points (such as an outlet's plug blade contacts or a toggle switch's switch contacts) which are also monitored by temperature sensors that are utilized in detecting overly-large temperature differentials indicative of unsafe conditions.

Implementation of the invention may occur in a wiring device having a plurality of terminals for attaching electrical supply wires to the wiring device, where a method for detecting and responding to unsafe thermal conditions in the wiring device includes monitoring temperature information from a plurality of temperature sensors that are in close proximity to each terminal and determining, from the temperature information, a temperature differential for each temperature sensor in comparison to each other temperature sensor. Each of the temperature differentials are compared to a reference safe temperature differential and electrical power to the wiring device is interrupted when any one of the temperature differentials exceeds the reference safe temperature differential.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows an electrical outlet that has been damaged in a fire due to a series fault;

FIG. 2 shows an illustrative computer system for use with embodiments of the present invention;

FIG. 3 shows an illustrative networked computer system for use with embodiments of the present invention;

FIGS. 4 and 5 show perspective views of a representative printed circuit board having wire connection terminals;

FIG. 6 shows a representative temperature sensor on a printed circuit board of a wiring device;

FIG. 7 shows a representative integrated circuit containing a temperature sensor on a printed circuit board of a wiring device;

FIG. 8 shows a representative discrete temperature sensor attached to a wiring terminal of a wiring device;

FIG. 9 shows a representative embodiment having the ability to detect temperature differentials;

FIG. 10 shows another representation of an embodiment for detecting temperature differentials; and

FIG. 11 shows a method in accordance with embodiments of the invention.

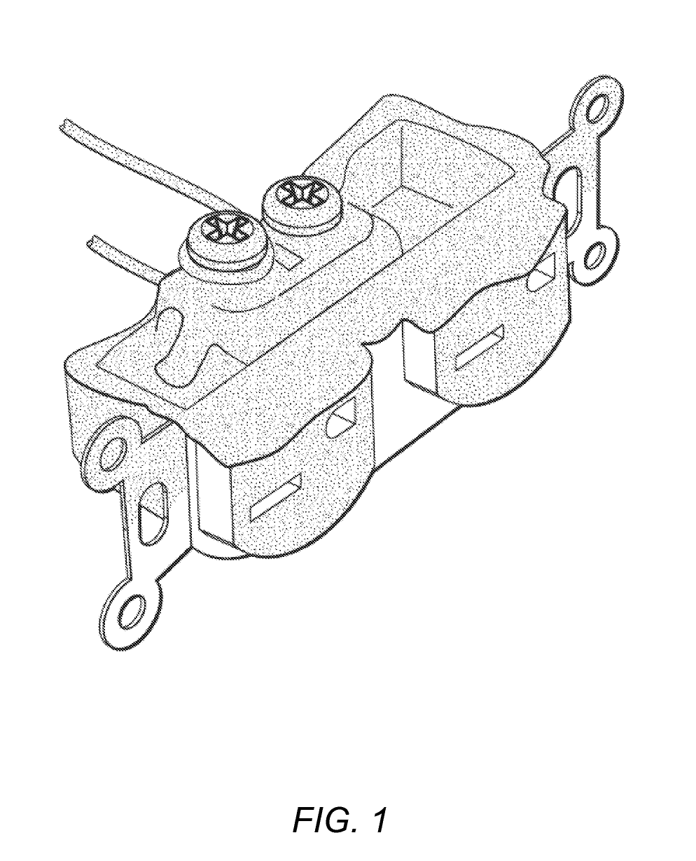

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide improved detection of series fault conditions, and provide improved response possibilities upon detection of such conditions. Some embodiments of the invention utilize electronic temperature sensors such as solid-state sensors and temperature sensors integrated into an integrated circuit. In some embodiments, the electronic temperature sensors are connected to a printed circuit board (PCB) that is connected to supply wire connectors, and in other embodiments they are directly connected to supply wire connectors. In some embodiments, differential temperature sensing, as an alternative to or in addition to direct temperature sensing, is provided.

The electronic temperature sensors can be quite small, and can therefore be located more closely to or directly on the supply wire connectors, which improves the rapidity with which localized heating can be detected. As the electronic sensors can be connected to PCBs and to other circuits, functionalities can be implemented using the PCBs and/or other circuits that cannot be provided with simple switching-type thermal sensors. Non-limiting examples of such additional functionality include integrated ground-fault detection, integrated safety features such as open-circuit, short-circuit, and ground fault detection, and integrated notification of detected fault conditions. Some such safety features and functionalities are described in, and embodiments of the invention may be used in conjunction with, systems, devices, and methods as described in U.S. patent application Ser. No. 11/539,171 filed Oct. 5, 2006 and naming Michael Baxter as inventor and U.S. Provisional Patent Application Ser. No. 60/724,248 filed Oct. 5, 2005 and naming Michael Baxter as inventor. Those patent applications are hereby specifically incorporated herein by reference for all they disclose.

Electronic sensors in accordance with embodiments of the present invention are capable of detecting overheating conditions at temperatures below those detected by current bimetallic temperature sensors, thereby improving the safety of electrical wiring devices and fixtures. Additionally, using electronic sensors, the threshold temperature for response can be selected or controlled to be at a variety of temperatures, including temperatures lower than those available with current bimetallic switching sensors. Detecting heating events and disconnecting power at lower temperatures improves safety. Embodiments of the invention may be incorporated into any type of wired electrical device, electrical fixture, or wiring device. Embodiments of the invention may be utilized for electrical fire hazard reduction, fire prevention, home safety, injury prevention, glowing connection detection, and series fault detection. Embodiments of the present invention may be utilized in residential, commercial, industrial, and military, among other, settings.

Embodiments of the invention provide a system for detecting unsafe thermal conditions in wiring devices including a wiring device having a plurality of terminals for attaching electrical wires to the wiring device, a plurality of temperature sensors, at least one temperature sensor being in close proximity to each terminal, and circuitry configured to monitor the temperature sensors and to interrupt power to the wiring device when a first temperature of one or more of the temperature sensors differs from a second temperature of at least one other of the temperature sensors more than a reference temperature differential. Some implementations of the system provide a wiring device having electrical contact points (such as an outlet's plug blade contacts or a toggle switch's switch contacts) which are also monitored by temperature sensors that are utilized in detecting overly-large temperature differentials indicative of unsafe conditions.

Embodiments of the invention utilize a method occurring in a wiring device having a plurality of terminals for attaching electrical supply wires to the wiring device, where the method is for detecting and responding to unsafe thermal conditions in the wiring device. The method includes monitoring temperature information from a plurality of temperature sensors that are in close proximity to each terminal and determining, from the temperature information, a temperature differential for each temperature sensor in comparison to each other temperature sensor. Each of the temperature differentials are compared to a reference safe temperature differential and electrical power to the wiring device is interrupted when any one of the temperature differentials exceeds the reference safe temperature differential.

Embodiments of the invention can incorporate various circuit elements, including microprocessors. Some embodiments of the invention can include electronic means for communicating over-temperature conditions to a home automation or other security system that can include one or more computer devices. Therefore, as some embodiments of the invention can be used with computer-type devices and computer-related elements, a background on such devices and elements is provided. Embodiments of the invention may rely on some software elements to control device hardware, including one or more internal microprocessors.

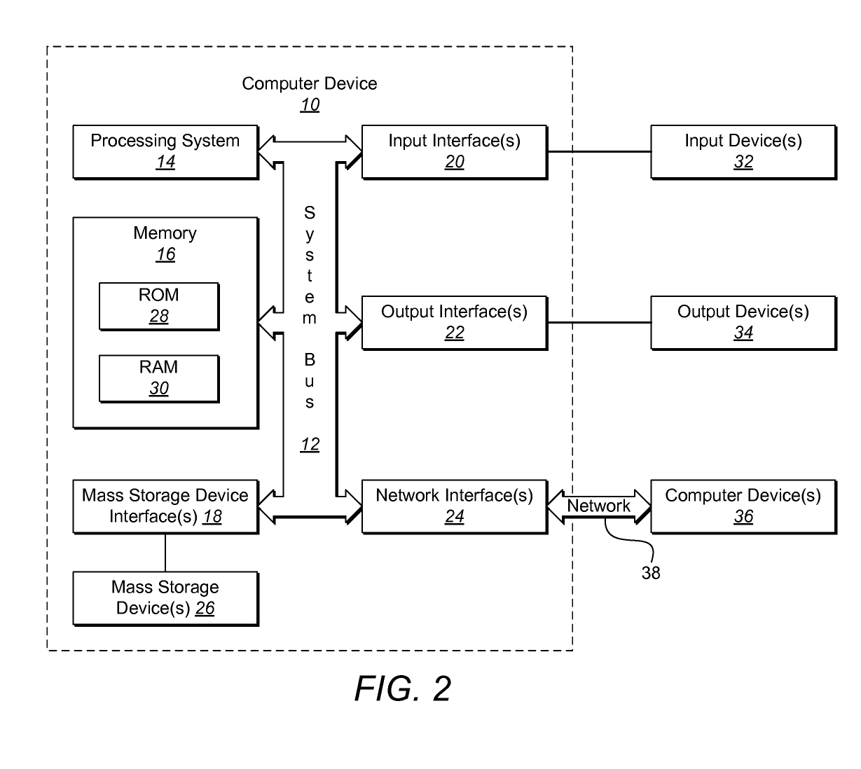

FIG. 2 and the corresponding discussion are intended to provide a general description of a suitable operating environment that may be implemented in conjunction with embodiments of the invention. One skilled in the art will appreciate that embodiments of the invention may be practiced using one or more computing devices and in a variety of system configurations, including in a networked configuration. While the methods and processes of the present invention have proven to be useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), field programmable gate arrays (FPGA), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system or device.

With reference to FIG. 2, a representative system for implementation with embodiments of the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

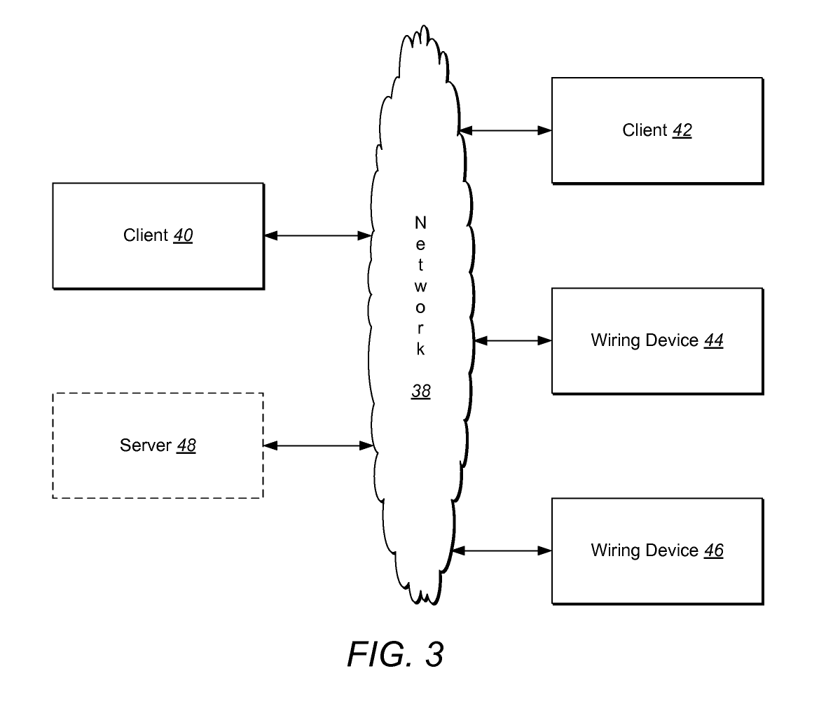

Thus, while those skilled in the art will appreciate that embodiments of the present invention may be practiced in a variety of different environments with many types of system configurations, FIG. 3 provides a representative networked system configuration that may be used in association with embodiments of the present invention. The representative system of FIG. 3 includes a computer device, illustrated as client 40, which is connected to one or more other computer devices (illustrated as client 42) and one or more wiring devices such as outlets, switches, fans, etc. (illustrated as wiring device 44 and wiring device 46) across network 38. While FIG. 3 illustrates an embodiment that includes a client 40, a client 42 and two wiring devices, wiring device 44 and wiring device 46, and optionally a server 48, connected to network 38, alternative embodiments include more or fewer clients, more or less than two wiring devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

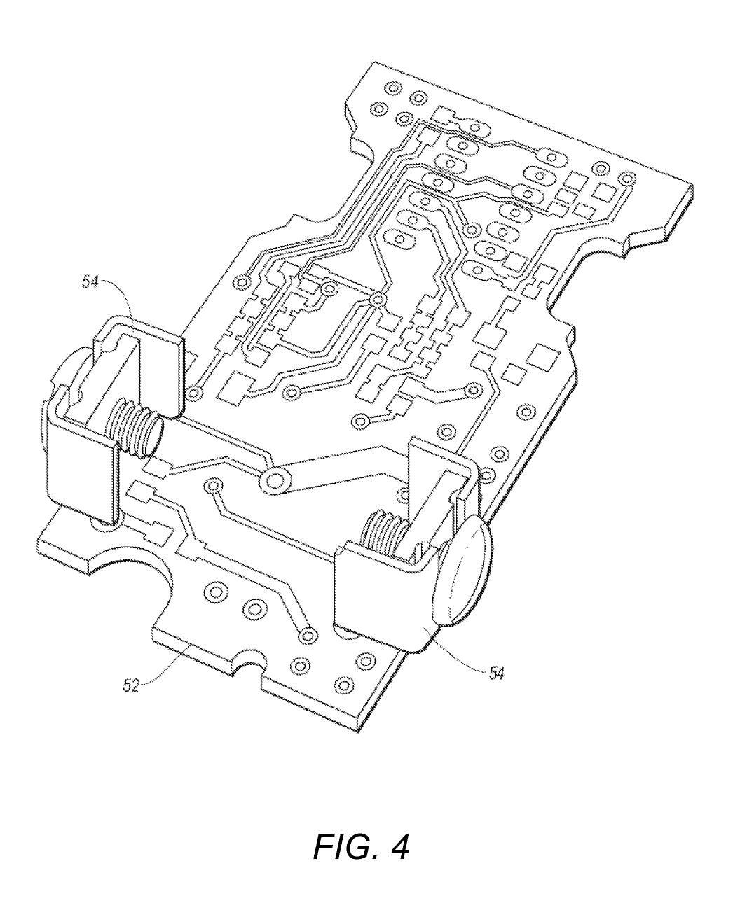

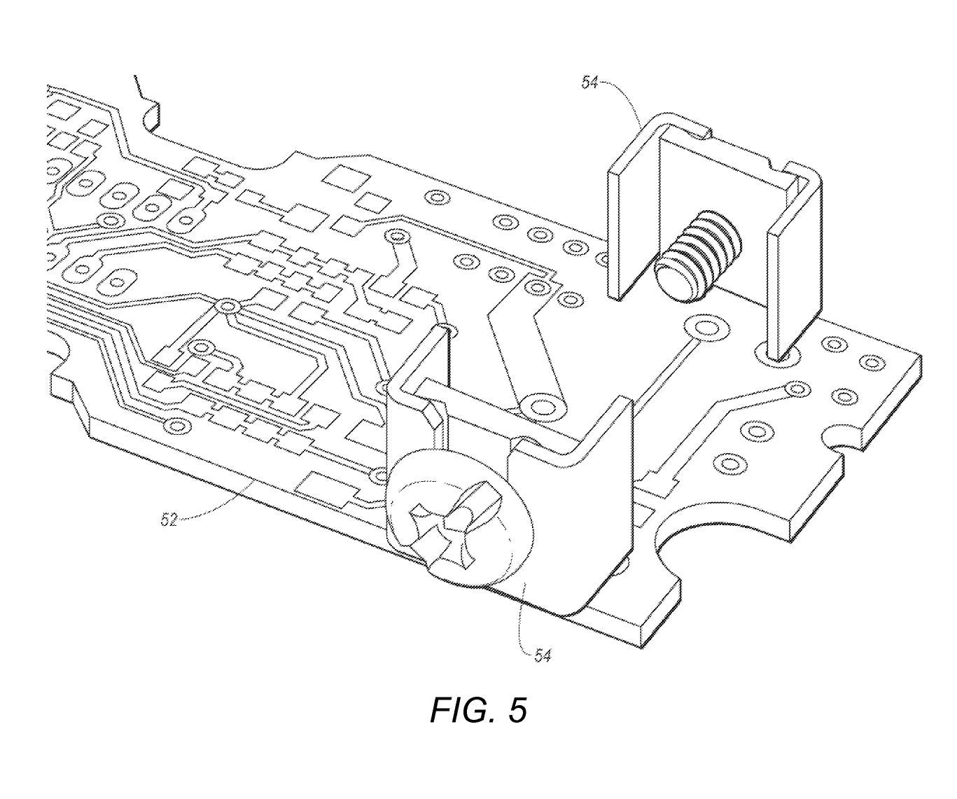

FIGS. 4-9 illustrate representative placement and embodiments of temperature sensors in accordance with embodiments of the present invention. FIGS. 4 and 5 show perspective views of a printed circuit board (PCB 52) that includes a pair of supply wire terminals 54. PCBs similar to the PCB 52 illustrated in FIGS. 4 and 5 may be included in a wide variety of wiring devices, including outlets, light switches, other toggle switches, light fixtures, ceiling fans, appliances, etc.

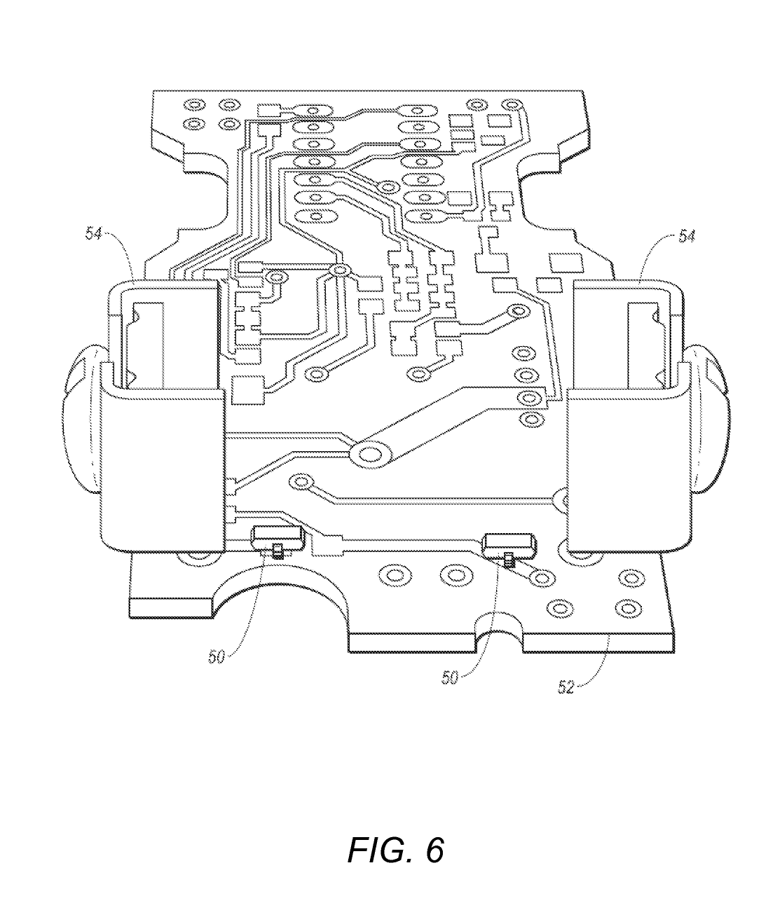

FIG. 6 shows a solid-state temperature sensor 50 that is soldered to the PCB 52 near a connection between the PCB 52 and the supply wire terminal 54. The supply wire terminal 54 is electrically and/or physically connected to the PCB 52. The close physical location of the temperature sensor 50 to the supply wire terminal 54 enables the temperature sensor 50 to promptly detect excessive heating. Additionally, one or more of the conductive traces of the PCB 52 may be used as a heat-conductive trace to improve the ability of the temperature sensor 50 to promptly detect over-heat conditions.

The various supply wire terminals 54 provides an attachment location for the supply wires (e.g. one or more each of hot/line, neutral, and ground, etc.), and temperature sensors 50 may be located near each supply wire terminal 54. FIG. 6 is an enlarged view of a portion of the PCB 52 of a wiring device, and therefore only two supply wire terminals 54 and sensors 50 are visible. Each supply wire terminal 54 may be of various materials, but brass and metal-coated (e.g. gold-coated) brass are common materials. In the illustrated supply wire terminal 54, a screw is provided to clamp a wire connected to the supply wire terminal 54. The temperature sensor ensures that electricity flowing through the connection does not cause excessive heating (such as due to an improperly tightened screw, an improperly located wire, or oxidation on the wire or supply wire terminal 54).

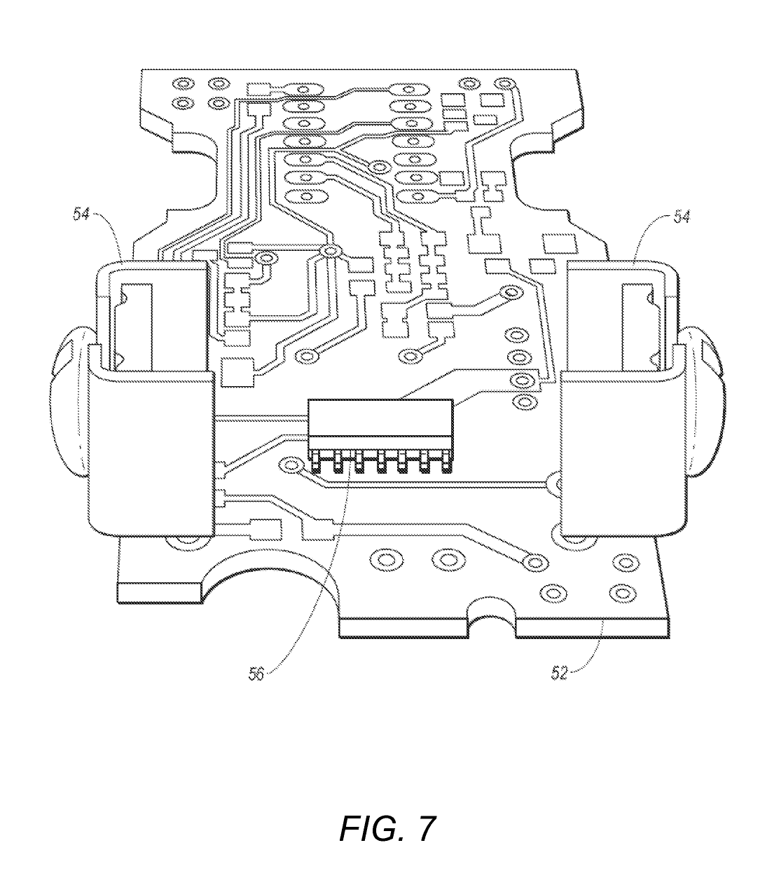

FIG. 7 illustrates an alternate embodiment, where an integrated circuit 56 is provided on the PCB 52. The integrated circuit 56 includes one or more integrated temperature sensors. The chip of the integrated circuit 56 may be located at a location physically close to the supply wire terminals 54 to assist in prompt over-temperature detection. Additionally, one or more traces of the PCB 52 may be used as a heat-conductive trace, further assisting the integrated circuit 56 to promptly detect over-heating conditions.

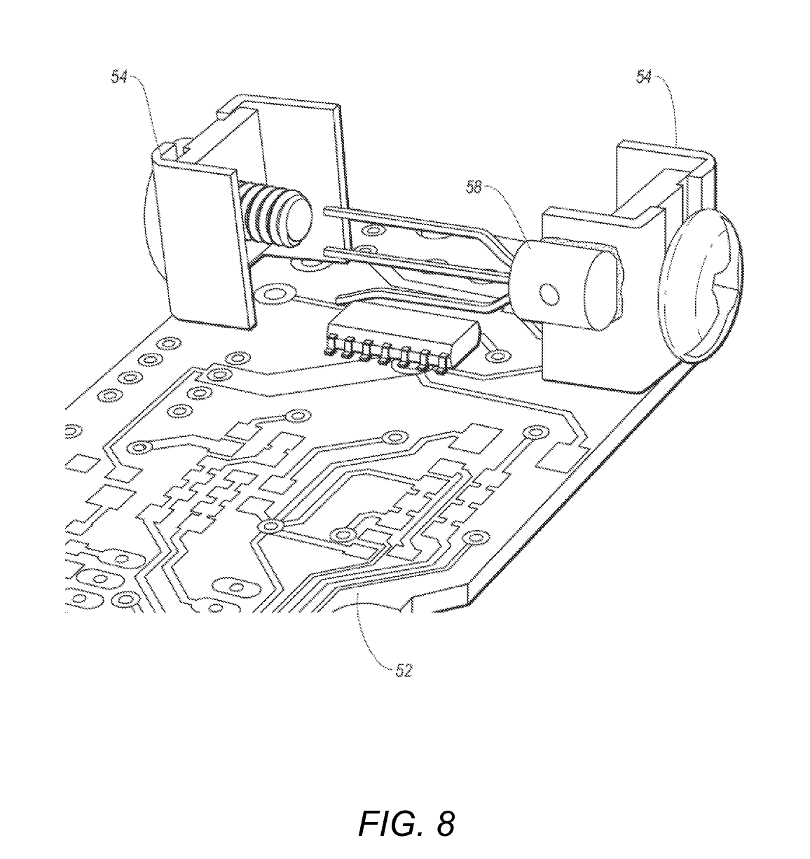

FIG. 8 illustrates another alternate embodiment. In this embodiment, a discrete temperature sensor 58 is provided, and is physically attached directly to the supply wire terminal 54 or supply wire terminals 54. Although the leads of the discrete temperature sensor 58 are shown in FIG. 8 as not being electrically connected to the PCB 52, it will be understood that the discrete temperature sensor 58, in practice, is so electrically connected or is electrically connected to some other device that can provide a reaction to detected over-heat conditions. The direct physical contact between the discrete temperature sensor 58 and the supply wire terminal 54 aids in promptly detecting any unwarranted heating.

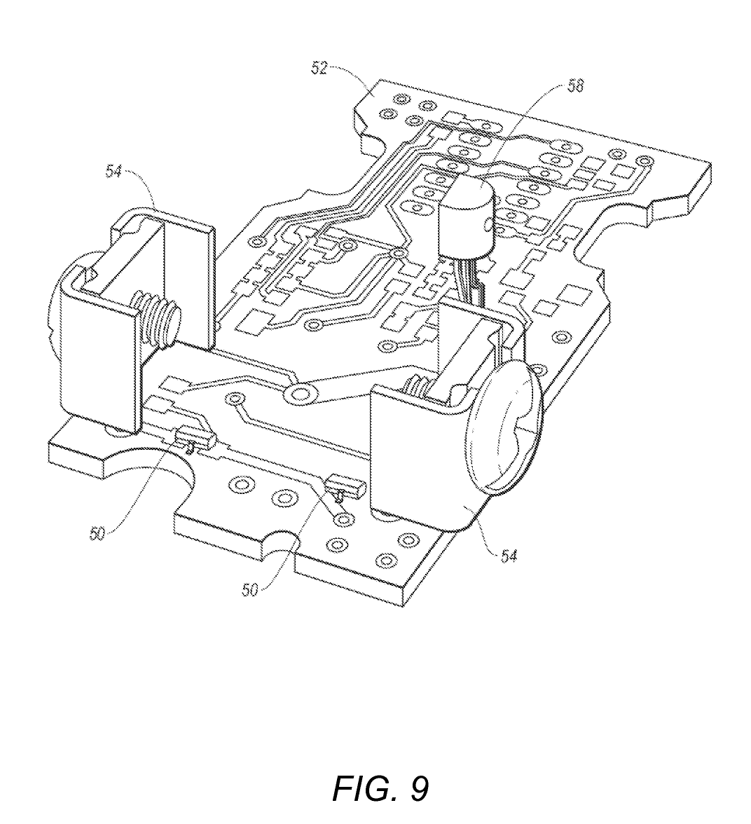

Another embodiment is illustrated by FIG. 9. This embodiment utilizes a pair of temperature sensors (or more), similar to any of the sensors discussed above, to detect temperature differentials. In the embodiment illustrated in FIG. 9, one of the pair of temperature sensors is the discrete temperature sensor 58, and the other of the pair is either of the temperature sensors 50. The pair of sensors measures the temperature rise of the supply connections. One sensor measures the ambient temperature, while the second sensor or configuration of sensors measures the supply connection temperature. In an alternative embodiment, one sensor or configuration of sensors measures the temperature at each connection or other point of possible unsafe heating. A circuit, either analog or digital, determines the difference between the various temperature measurements.

Configurations such as the configuration of FIG. 9 may be useful, for example, in environments where the ambient temperature is relatively hot, such as temperatures approaching the temperature value that would cause a determination of an over-heat situation in a particular sensor. Another situation where this configuration may be useful is in cold climates or situations where colder temperatures of use are encountered. In such situations, sensors that detect temperature differentials can more quickly detect a fault based on a temperature differential, even if the point of localized heating has temperatures lower than would normally trigger detection of a fault with a single sensor. For example, if the ambient temperature is below freezing, but a detected temperature at a supply wire terminal 54 is, say, eighty degrees Fahrenheit, embodiments with a differential-sensing ability might determine that a fault condition exists.

Differential-sensing embodiments therefore provide better protection against series faults caused by bad connections, oxidation, and the like. In some embodiments, one sensor can be dedicated to detecting ambient temperatures, but this extra sensor is not present in other embodiments. Instead, because series faults typically occur at only one electrical connection at a time, or otherwise vary in the severity of the fault condition even when multiple faults are present, the temperature differential between the various connection locations or other locations of potentially-unsafe heating will vary sufficiently to be detected.

Additionally, these systems can also detect some unsafe thermal conditions in devices external to the device containing the thermal detection systems according to embodiments of the invention, as will be discussed below. It should also be understood that differential-sensing embodiments may also detect over-temperature conditions where a reference maximum absolute temperature is exceeded, even if detected temperature differentials across a wiring device remain within normal bounds.

Therefore, a system for detecting unsafe thermal conditions in a wiring device using temperature differentials includes a plurality of temperature sensors. The wiring device also includes a plurality of terminals for attaching electrical wires to the wiring device. A temperature sensor is in close proximity to each terminal, in any of a variety of fashions, such as those discussed above (physical proximity, thermal proximity through a heat-conductive trace, etc.). In at least some embodiments, a single temperature sensor may monitor the temperature of more than one terminal; in such instances at least one other temperature sensor is present in the wiring device and is located so as to reliably detect temperature differentials.

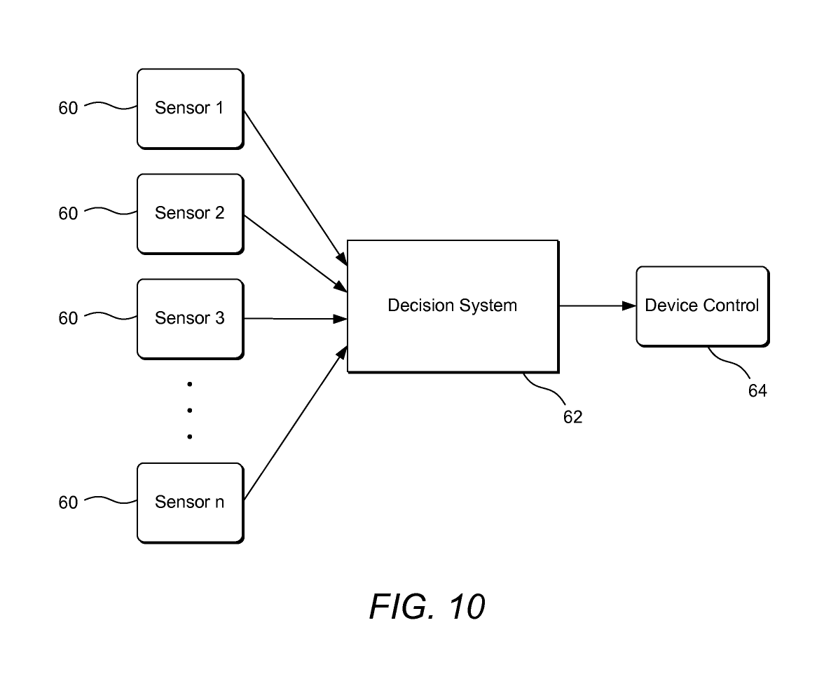

The wiring device also includes circuitry configured to monitor the temperature sensors and to interrupt power to the wiring device when differences between detected temperatures of any two sensors exceeds a maximum allowable temperature differential. FIG. 10 provides an illustration showing a block layout of a configuration of the wiring device. The system includes a plurality of sensors 60, the number of which can vary widely depending on the wiring device and the number of terminals of the wiring device. Additionally, in some embodiments, additional sensors 60 can be placed at other electrical contact points besides the terminals, such as other points of potentially-unsafe localized heating.

For example, in a receptacle or outlet, the plug blade contacts can be sources of localize heating for a variety of reasons. For example, if the plug blade contacts have become worn and/or oxidized, the quality of contact between the plug blades and the plug blade contacts may degrade, causing a series fault and unsafe heating. As another example, if a series fault is located in a device plugged into the outlet, heat from the plugged-in device may pass through the plug blades into the outlet. In this way, sensors 60 placed proximate the plug blade contacts may serve to detect unsafe heating conditions in devices connected to the outlet.

Another example of a wiring device having additional electrical contact points is a light switch or other toggle switch. Such devices have switch contacts for making and breaking electrical connections to devices connected to the switch. Such switch contacts can become worn or oxidized over time or may suffer from a manufacturing defect that may lead to unsafe thermal conditions which can be detected by measuring temperature differentials using sensors 60 located proximate the switch contacts. Of course, it will be understood that additional terminals and/or electrical contact points of any of a variety of types may be found on embodiments for duplex (and triplex) devices, such as duplex outlets, duplex switches, and duplex combination devices, among other examples.

As illustrated in FIG. 10, the system includes a decision system 62, which monitors the temperature sensors 60 and determines the temperature differentials between the various sensors. The decision system 62 also compares the detected temperature differentials to a reference temperature differential, and determines whether any one or more of the temperature differentials exceeds the reference temperature differential. If so, the decision system 62 determines that remedial action should be taken, such as interrupting power to the wiring device, and a device control 64 is used to take the appropriate action, as will be discussed in more detail below. In some embodiments, the decision system 62 and the device control 64 are implemented as circuitry, which may or may not include a dedicated microprocessor, configured to monitor the temperature sensors and to interrupt power to the wiring device when one of the temperature differentials exceeds the reference temperature differential.

Various types of sensors 60 may be used in differential-sensing embodiments of the invention. In some embodiments, simple temperature sensors are used as the sensors 60. In one type of embodiment, diodes having a temperature-dependent forward voltage, such as a common rectifier diode. As the forward voltage of the diodes is temperature-dependent, a microprocessor or other decision system 62 may sample the forward voltages and make a determination as to whether one or more of the sensors 60 is excessively warm in comparison to any of the other sensors 60.

Another embodiment uses discrete thermostats placed in close proximity to the points of interest. The thermostats change output state in the case that an elevated temperature occurs. The output of the thermostats is used to determine whether localized heating is occurring, such as by a majority-rules situation, where if all thermostats are in the same state there is no problem. If, however, one or more thermostats is in a different state, a problem is detected.

Still another embodiment utilizes a mechanical difference system. In this type of embodiment, thermally-sensitive components, such as bi-metallic strips, move in relation to temperature. If each thermally-sensitive component moves in concert with the others, then there is no trigger signal to take action. In the case where one or more thermally-sensitive components moves independently of the others, then this triggers a signal to take action.

It should be understood that any of the above-described differential-sensing embodiments may also be configured to respond to absolute maximum temperatures. For example, even if the detected temperature differentials from all the sensors 60 is within acceptable ranges (e.g. below a selected reference maximum temperature differential), the overall temperature of the wiring device may be determined to be above a maximum reference temperature (such as a temperature at which it is expected that deformation of the wiring device may occur, or a selected reference temperature that is selected to be below a temperature of expected deformation, or a selected reference temperature likely indicative of a fault condition and not expected during normal use). The wiring device (e.g. the decision system 62 and device control 64) may be configured to also detect such a condition and respond appropriately (e.g. interrupt power to the wiring device). This behavior provides an additional safety check to prevent unsafe thermal conditions at the wiring device.

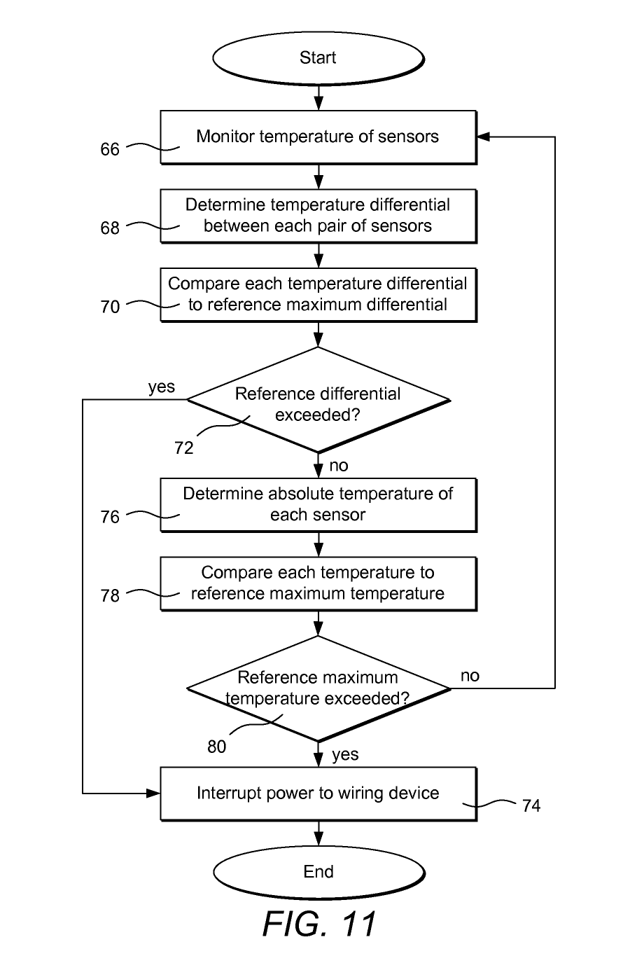

In accordance with the discussed differential-sensing embodiments, FIG. 11 illustrates features of methods in accordance with embodiments of the invention. It should be understood that the specific method of FIG. 11 is intended to be illustrative and not limiting, and that some methods in accordance with embodiments of the invention utilize steps other than those specifically illustrated and/or in different orders than the order illustrated. Additionally, some embodiments omit or add steps to the method illustrated in FIG. 11. Therefore, the scope of the invention should be determined by reference to the claims, and is not limited to the specific method illustrated in FIG. 11.

According to the illustrated method, execution begins at step 66, with monitoring of the sensors (such as with the decision system 62). At step 68, a determination is made as to the temperature differentials between each pair of sensors. For example, if a particular wiring device has only two sensors, Sensor A and Sensor B, a single temperature differential is determined between Sensor A and Sensor B (or between Sensor B and Sensor A). If, however another wiring device has three sensors, Sensor C, Sensor D, and Sensor E, then three temperature differentials are determined, namely C to D (or D to C), C to E (or E to C), and D to E (or E to D). With four sensors, six temperature differentials may be determined, etc. with increasing numbers of sensors.

At step 70, each temperature differential is compared to a reference maximum temperature differential. The maximum reference temperature differential is typically chosen to be one that allows for normal temperature variances that might occur across the wiring device during normal use, but that, if exceeded, is indicative of a fault condition or other unsafe temperature condition. Execution then proceeds to decision block 72 for a determination as to whether one or more of the determined temperature differentials exceeded the maximum reference temperature differential. If yes, execution proceeds to step 74, where a remedial action is taken, such as completely interrupting power flow through the wiring device, or limiting power use at the wiring device significantly, such as being limited to illumination of a warning light or sounding an alarm. Very-limited power draws such as illuminating an warning light or sounding an alarm will typically not draw sufficient power to continue causing dangerous overheating at a fault condition.

If, however, none of the determined temperature differentials exceeds the reference temperature differential, execution then proceeds to step 76, where a determination is made as to the absolute temperature of each sensor. At step 78, each determined temperature is compared to a reference maximum absolute temperature. This allows detection of situations where the entire device is overheated, but overheated evenly. Thus, at decision block 80, a determination is made as to whether any of the detected absolute temperatures exceeds the reference maximum absolute temperature. If so, execution proceeds to step 74 for the remedial action. If not, execution loops back to the first step for continued monitoring of the temperature sensors. The process may execute continuously whenever the wiring device is supplied with power.

It should be understood that references herein to detecting/determining temperatures and temperature differentials should be understood to include detection and determination of signals representative of temperatures and temperature differentials, even if actual temperature measurements and/or temperature differences in degrees Fahrenheit or degrees Celcius are not actually detected/determined. For example, in a device using diodes having a temperature-dependent forward voltage, the decision system 62 may make all actual comparisons with respect to detected voltages (representative of temperatures), voltage differences (representative of temperature differences), reference voltage differentials (representative of reference temperature differentials), and reference voltages (representative of reference temperatures). Similarly, other temperature-representing signals (e.g. currents, etc.) or combinations of signals may be used instead of voltages in place of actual temperature calculations. Therefore, the use of the term “temperature” in the specification and claims should be understood to refer to actual temperatures and/or signals representative of temperatures.

Temperature-differential-detecting wiring devices can be used in many applications. Two examples include receptacles and switches such as toggle switches for lighting or other electrical control. A wall receptacle has several points of common failure that can lead to excessive heating: the plug blade contacts and the supply terminal screws. Thus, in embodiments of the invention, temperature sensors can be placed on each of the plug blade contacts and each supply wire terminal. A controller monitors each of these sensors for differences indicative of an unsafe condition. For example, if one plug blade contact was heating excessively but the other not, this would be indicative of a worn or poor connection between the plug blade and the plug blade contact of the receptacle.

This embodiment allows such a receptacle to also detect unsafe heating from a device plugged into the receptacle. For example, if a night light, AC-DC converter such as a cell phone charger, or other small device were to develop excessive heat, this heat would be conducted up one or both of the device's plug blades into the receptacle. The temperature sensor(s) in the receptacle would indicate that one or both of the plug blade contacts is at an elevated temperature relative to one or more of the temperature of the supply wire terminals. In a duplex receptacle, the temperature in one set of plug blade contacts could also be compared against the temperature of the other set of plug blade contacts.

As another example, if a supply wire terminal developed a high resistance and consequently heated excessively, the sensor associated with the terminal would so indicate. The elevated temperature would be compared to the temperature of the other supply wire terminal(s) and/or to the plug blade contacts to detect the localized excessive heating.

In a toggle switch, such as a light switch or similar device, a temperature sensor could be placed on each supply wire terminal as well as on or near one or more of the switch contacts. If any one of these heated excessively, its temperature would be compared to the temperatures of the other sensors to determine whether the heating is inappropriate.

Embodiments utilizing differential temperature detection may be more effective at detecting unsafe heating conditions and preventing fires than alternatives detecting maximum temperatures only (e.g. devices using sensors with fixed and independent thresholds). Those systems typically utilize a high temperature threshold to minimize inappropriate tripping such as might be encountered in installations in a hot environment. Differential temperature detection removes the effect of ambient temperature from the detection scheme as well as the effect of normal temperature rise encountered during normal use.

Embodiments of the invention, such as those described above, solve the problems with existing devices by detecting problematic heating caused by series faults directly. Problematic heating is detected by one of various configurations of solid-state temperature sensors or other temperature sensors and the PCB 52 or other decision system 62 and device control 64. The PCB 52 may serve various functions, including as a mounting medium for the sensors, as a mounting medium for and as a part of supporting circuitry, and as a mounting medium for the supply connectors or terminals. The solid-state or other sensors can be very small, allowing them to be placed near or at the location where heating occurs. Additionally, copper traces or other copper features of the PCB 52 are easily designed to act as thermal conduits between the supply wire connectors or terminals, which may be brass, and the sensors, assisting in reliable detection of over-temperature conditions, such as those caused by loose wires.

Embodiments of the invention improve on the interlocking mechanical systems utilizing bimetallic switching. Advantages of the embodiments of the invention include simplicity, a more direct thermal path to the thermal sensors, smaller size, and greater ease of integration with other safety systems. For example, the thermal detection systems can be integrated with ground fault circuit interruption (GFCI) circuitry, to provide increased protection against a wider variety of fault conditions. Thermal detection features as described above can also be incorporated with other safety features (in addition to GFCI or alternatively to GFCI), such as features that detect various faults, including short circuits, open circuits, and ground faults without ever supplying line voltage to the outputs of the wiring device (such as for a plug receptacle or outlet).

Thermal detection systems in accordance with embodiments of the invention can be integrated with safety features provided by the electronic nature of the thermal sensors. For example, the electronic nature of the system permits relatively easy customization of the fault response. One example of customization of the fault response is flexibility in setting the response temperature. Another example is selective programming of the response to a detected fault, such as permanent disabling of the wiring device or permitting reset of the device after a detected fault.

Still another example of customization is the activation of an audible alarm and/or visual warning lamp upon detection of a fault or near-fault condition. As discussed above, wiring connection faults lead to heat because of the current passing through the increased resistance of the faulty connection. As an example, the current passing through an outlet to a plugged-in load can be quite substantial, reaching currents over ten amps. However, the current necessary to provide power to circuitry within the outlet can be much smaller, on the order of several milliamps to tens of milliamps.

Thus, upon detection of a fault condition, the circuitry may selectively cut power to the load plugged into the outlet, but may continue to provide power to the internal circuitry of the outlet, permitting illumination of a warning light and/or activation of an audible alarm. In many instances, the few milliamps drawn through the faulty connection for such activities is insufficient to cause significant heating, and the over-heating problem detected by the outlet naturally subsides even with the warning light and/or audible alarm activated. If, however, the detected heat fails to subside within a reasonable time, the fault response can be modified to disable even the power draw necessary to provide the warning light and/or audible alarm.

In some embodiments, the circuitry included in the wiring device may be communicatively coupled to a home automation system or to an alarm system, such as by a wired or wireless connection. Such embodiments can communicate detected over-temperature conditions to the home automation system or other security system, which may result in an appropriate response, including summoning of the fire department or other assistance.

Embodiments of the invention may be incorporated into a wide range of systems, devices, wiring devices, and appliances. Non-limiting examples include AC wall switches, AC simplex and duplex receptacles, light fixtures, extension cords, appliance plug-ends, stand-alone modules placed in a junction box, etc.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A system for detecting unsafe thermal conditions in wiring devices comprising:
a wiring device having a plurality of terminals for attaching electrical wires to the wiring device;
a plurality of temperature sensors, at least one temperature sensor being in close proximity to each terminal; and
circuitry configured to monitor the temperature sensors and to interrupt power to the wiring device when a first temperature of one or more of the temperature sensors differs from a second temperature of at least one other of the temperature sensors more than a reference temperature differential.

2. A system as recited in claim 1, wherein the wiring device comprises one of:
an outlet;
a light switch;
a light fixture;
an appliance;
an extension cord; and
a circuit breaker.

3. A system as recited in claim 1, wherein the temperature sensors comprise solid-state devices.

4. A system as recited in claim 1, wherein the temperature sensors comprise diodes having a temperature-dependent forward voltage.

5. A system as recited in claim 4, wherein the circuitry comprises a microprocessor that samples the forward voltages of the diodes and determines if one or more of the forward voltages differs from at least one other of the forward voltages more than a reference voltage.

6. A system as recited in claim 1, wherein the temperature sensors comprise discrete thermostats.

7. A system as recited in claim 1, wherein the temperature sensors comprise mechanical thermally-sensitive components, and the circuitry monitors movement of the components to determine whether the components move in concert or not.

8. A system as recited in claim 1, wherein a temperature-sensitive element of at least one temperature sensor is in physical contact with each terminal.

9. A system as recited in claim 1, wherein the wiring device comprises a wall receptacle having a plurality of plug blade contacts, and wherein at least one temperature sensor is in close proximity to the plug blade contacts.

10. A system as recited in claim 1, wherein the wiring device comprises a toggle switch having a plurality of switch contacts, and wherein at least one temperature sensor is in close proximity to the switch contacts.

11. A system for monitoring unsafe temperature conditions in a wiring device, the system comprising:
a wiring device comprising:
a plurality of terminals for attaching electrical supply wires to the wiring device; and
a plurality of electrical contact points for providing supply of electricity from the wiring device to other electrical devices;
a plurality of temperature sensors, at least one temperature sensor being in close proximity to each terminal and at least one temperature sensor being in close proximity to each electrical contact point; and
circuitry configured to monitor the temperature sensors and to interrupt power to the wiring device when a first temperature of one or more of the temperature sensors differs from a second temperature of at least one other of the temperature sensors more than a reference temperature differential.

12. A system as recited in claim 11, wherein the wiring device comprises a wall receptacle and the electrical contact points comprise plug blade contacts.

13. A system as recited in claim 11, wherein the wiring device comprises a toggle switch and the electrical contact points comprise switch contacts.

14. A system as recited in claim 11, wherein the temperature sensors comprise diodes having a temperature-dependent forward voltage.

15. A system as recited in claim 14, wherein the circuitry comprises a microprocessor that samples the forward voltages of the diodes and determines if one or more of the forward voltages differs from at least one other of the forward voltages more than a reference voltage.

16. In a wiring device having a plurality of terminals for attaching electrical supply wires to the wiring device, a method for detecting and responding to unsafe thermal conditions in the wiring device comprising:
monitoring temperature information from a plurality of temperature sensors that are in close proximity to each terminal;
determining, from the temperature information, a temperature differential for each temperature sensor in comparison to each other temperature sensor;
comparing each of the temperature differentials to a reference safe temperature differential; and
interrupting electrical power to the wiring device when any one of the temperature differentials exceeds the reference safe temperature differential.

17. A method as recited in claim 16, wherein the wiring device comprises a plurality of electrical contact points for providing supply of electricity from the wiring device to other electrical devices, the method further comprising monitoring temperature information from one or more additional temperature sensors in close proximity to the electrical contact points.

18. A method as recited in claim 17, wherein the wiring device comprises a wall receptacle and the electrical contact points comprise plug blade contacts.

19. A method as recited in claim 17, wherein the wiring device comprises a toggle switch and the electrical contact points comprise switch contacts.

20. A method as recited in claim 16, further comprising:
determining, from the temperature information, an absolute temperature measurement of each of the temperature sensors;
comparing each the absolute temperature measurement to a reference maximum absolute temperature; and
interrupting electrical power to the wiring device when any one of the absolute temperature measurements exceeds the reference maximum absolute temperature.
